(19) United States
(12) Patent Application Publication
(10) Pub. No.: US 2010/0023365 A1
(43) Pub. Date: Jan. 28, 2010

(54) Software database driven accounting, contact management, marketing automation and communication system, method and compilation for managing multi-tiered incentive referral compensation and charitable contributions applied to social or business networking websites selling goods or services in electronic commerce

(76) Inventor: Thomas Anthony Cifelli, Scottsdale, AZ (US)

Correspondence Address: Thomas A Cifelli;Cif Corp, Box 190, Scottsdale, AZ, 85252, US

(21) Appl. No.: 12/497,855

(22) Filed: Jul. 6, 2009

Related U.S. Application Data
(60) Provisional application No. 61/082,884, filed on Jul. 23, 2008.
(60) Provisional application No. 61/084,020, filed on Oct. 29, 2008.
(60) Provisional application No. 61/084,044, filed on Jul. 28, 2008.

(51) Int. Cl. G06Q 30/00; G06Q 10/00

(52) U.S. Cl. 705/7; 705/14.16

(57) ABSTRACT

This data processing and online computer network software application system and method specifically addresses deficiencies of current systems and methods in generating rapid and sustainable word-of-mouth and viral customer referral and retention activity through automation of networking, computing, tracking, storing, reporting, analyzing and paying multiple levels of residual referral compensation to registered users (“Member” or “Members”) of an online interactive social or business networking enabled website (“Sponsor” or “Sponsors”) also offering charitable donation inclusion as part of its electronic commerce network marketing and transactional management system.

### CROSS-REFERENCE TO RELATED APPLICATIONS

Patent application Ser. No. 12/496,980, filed Jul. 2, 2009 titled “A software database driven accounting, contact management, marketing automation and communication system, method and compilation for managing multi-tiered incentive referral compensation and charitable contributions applied to social or business networking websites selling goods or services in electronic commerce.”

Provisional Application No. 61/082,884 filed Jul. 23, 2008 titled “A data processing and online computer network application software system and method for managing customer referrals, online order processing, incentive compensation and rewards programs, award fulfillment and network marketing member interaction in a distributed global computer and electronic hand held device network.”

Provisional Application No. 61/084,020 filed Jul. 28, 2008 titled “Word-of-Mouth network marketing computer program, method and system.”

Provisional Application No. 61/084,044 filed Jul. 28, 2008 titled “A data processing and computer software system and method for managing word-of-mouth and network marketing customer referrals, related online order processing, and associated compensation incentives and rewards programs in a distributed global computer and electronic hand held device network.”

### Prior Art References:

Prior art examples that do not conflict with the unique embodiments of this Invention include:

Application #20030050857 (Mar. 13, 2003) Electronic Mobile Pet Shop

U.S. Pat. No. 6,061,660 (May 9, 2000) System & method for incentive programs and award fulfillment

Application #20070288395 (Dec. 13, 2007) Method and system for network marketing

Application #20080140520 (Jun. 12, 2008) System and method for providing coupons

Application #20080120155 (May 22, 2008) Systems and method for distributing targeted incentives to financial institution customers

U.S. Pat. No. 7,054,830 (May 30, 2006) System and method for incentive programs and award fulfillment

U.S. Pat. No. 7,359,871 (Apr. 15, 2008) System and method for managing recurring orders in a computer network

U.S. Pat. No. 7,149,707 (Mar. 25, 2002) Method and apparatus for compensating a plurality of franchise participants in a multi-level sales force

U.S. Pat. No. 6,980,962 (Dec. 27, 2005) Electronic commerce transactions within a marketing system that may contain membership buying opportunity

Patent Application #20080033744 titled “Method, System, and Computer Program Product for Multi-Level Marketing, dated Feb. 7, 2008.

U.S. Pat. No. 6,421,648 titled “Data processing for the management of a differential continuous compensation plan, issued Jul. 16, 2002.

### BACKGROUND OF THE INVENTION

### Field of the Invention

The present invention is generally related to multi-level marketing, network marketing, direct sales and marketing, user rebates and rewards, incentive marketing, online user relationships, interaction and service management tools, and in particular related automated administrative accounting, reporting and user activity tracking technology deployed by interactive e-commerce community websites.

This method and system is for use and adoption by e-commerce websites that offer goods and services for online purchase and remunerates participant users (pays them in cash, site credits or other rewards) that register online as a member and directly or indirectly introducing third parties to also register and join the DMR. This invention is superior to existing member reward programs and existing multi-level marketing programs that generally have financial barriers to entry, complexity of compensation programs and levels, retention difficulties, and often minimum purchase requirements. This inventive system of rewarding parties for word-of-mouth referrals can be offered completely free and not as a business opportunity. It is a unique automated method and system for tracking data pertaining to word-of-mouth generated referral activity and resulting transactions with variable revenue sharing compensation models. And this inventive system addresses and incorporates automated variable charitable giving connected to electronic commerce transactions.

### SUMMARY OF THE INVENTION

This DMR system, method and Invention takes advantage of and integrates all of the resources and features of existing technology, describes advancements in existing technology, to build an efficient personal and business online relational database and network amongst individuals and entities with shared interests including but not limited to creating low stress high satisfaction financial and business success through participating in economically beneficial residual income producing activity offering flexible work hours and flexible location opportunities essentially designed to integrate economically beneficial activity and relationships with social and personal activity and relationships in such a manner as to eliminate the historical negative aspects and stress associated with such opportunities.

This DMR method and Invention enables technology advancements to be utilized for the first time in a meaningful way that will cause a compression in the costs of marketing and distributing goods and services, and enable consumers to access higher quality goods and services at increasingly relatively lower prices than other sales and marketing methods.

This DMR method system and Invention enables a further integration over prior technology of individual's personal and business networking interests by enabling online applications that attract individuals with shared lifestyle interests while overlaying those interests with financial and business interests and incentives.

This DMR method and system and Invention enables greater flexibility for non-profits, charitable, religious, educational and governmental entities to join the network and benefit greatly by participation in and promotion of the DMR Sponsor online community and areas of interests by sharing the DMR content and technology with their respective constituency, donors, employees and other parties that these entities help, interact with and depend upon.

This DMR system and Invention enables installation of different compensation reward structures by individual product and service added to the website or online community, a feature not ever before incorporated into a network or multi-level marketing type of promotional system.

The Invention covers a larger group of prospective participants for membership because it does not require sponsorship or invitation as do all other DCCPs and MLMs.

The Invention allows for automated or customized division of compensation and rewards credit to referring or sponsoring members amongst multiple sponsors and allows a variable allocation amongst the designated Sponsors.

The Invention has features that can be activated to allow a Member to change the sponsoring Member or Members at any time should the Sponsor elect such flexibility into the contractual terms of the Member relationship.

The Invention allows full membership rights without any spending or purchase requirements.

The Invention allows Members to reduce or assign some to all of their compensation and reward rights for a limited specified period or perpetually and to also change such election at anytime in the future.

The Invention allows sponsoring websites to change the terms of participation and compensation at any time, and to customize the terms of compensation to Members on a product by product and service by service basis.

The Invention enables auto generated changes to the member terms and conditions when sponsoring websites change compensation terms and condition parameters.

### Description of Prior and Related Art

This method and Invention differentiates itself by feature and depth or functionality over existing multi-level marketing programs and systems. None of the existing systems integrate online social and business networking resources with relational marketing and direct multi-level compensation programs, nor do they have the simplicity and flexibility of this DMR Invention.

Existing MLM and network marketing systems including but not limited to SSBA, DCCP, and Non-Differential systems all have higher costs of compensation, higher administrative complexity and costs, higher recruiting and training expenses, and less pricing and compensation structure flexibility than this DMR system.

And existing “competing” systems have very high failure rates due to their being unable to achieve sustainable success for most of the membership as a result of a combination of defects that are all addressed and eliminated by the DMR design and technology and methods.

This DMR method and Invention makes full utilization of globally available wireless and hard wired broadband Internet that has only recently been generally available to the public (less than 10 years of use by most people and organizations). This new widely disseminated broadband Internet technology enables many features and advancements in this DMR Invention that prior network and multi-level marketing companies could not have anticipated and therefore have not been designed to take advantage of or incorporate into their systems. The advent of powerful portable digital devices connected to the Internet on one carrier signal or another, and the ability to geographically track users, also enables interaction variables amongst users of the Invention not available to or anticipated by prior systems and art.

This Invention is disruptive of prior network marketing and product and service distribution technologies and practices because it fully integrates and utilizes the latest in software, transactional and communication technology. Due to the design and integration of its many varied but related features and resources, this DMR Invention enables the most rapid and efficient growth of a relational database of people sharing common interests ever invented. Resultingly prior art had to offer more costs and complexity, and more simplicity, in order for the systems and technology to be understood and attractive to prospective members given the time energy and costs associated with their use and deployment and distribution of it for their benefit. Since this DMR Invention technology enables rapid expansion of a member's relational network with very little effort in an easy to understand and communicate business and personal networking model, the less expensive compensation structure anticipated to be selected and installed by most Sponsors desiring to utilize a variation of the DMR system resources will nevertheless generously reward members for participation in the network, with the reward increasing proportionate to member efforts and enabling team building amongst members of the same level and members of disparate member “trees” and “branches” verses the inherent conflicts of prior systems and art.

Existing Non-Differential, Stair-Step Differential, and Differential Continuous Compensation Plans do not allow as this Invention does:

Free registration and membership with no reduction in associated compensation or rewards

No impact whatsoever from payouts of compensation and rewards to one member upon the level and frequency of compensation or reward to another member eliminating all possible conflicts of interest in promoting and building growth of subsequent membership

Members to modify one or more times and customize one or more time for fixed or variable periods of time the terms of their compensation both in amounts and allocation

No limitations or conditions upon joining membership

No requirement of spending money, sponsoring new members, or otherwise participating in website activity for continuation of membership in the residual Rewards program

Connecting flexible single or multi-leveled charity donations with member referral residual income and rewards

Enabling registered users to designate charities of their choice

Enabling charities to join as members and earn both member referral rewards while being an optional charity beneficiary designee of itself and other members

A simplified and easy to understand multi-level member residual and reward compensation system that requires no up front or continuing fees or spending requirements, no complex mathematical equations or variables, and no group compensation aggregation formulas.

This Invention does not require adopting websites to have any electronic systems or accounting controls linked to customers, as one embodiment of the Invention is a complete turn-key virtually hosted application and solution enabling Sponsors to incorporate the DMR system without any increase in business human or capital equipment and resources as required of all competing or similar systems.

### Object and Advantages

The object of this invention is to increase the attractiveness and speed of growth of online business and personal networking by creating a simple easy to administer yet dynamic database driven website community of users that is free, offers the opportunity to earn substantial compensation and rewards without requiring any investment of time or money of the user member, is designed with increased efficiency and fairness to allow a reduction in typical sales and marketing expenses and thereby allowing delivery of products and services for less than existing systems to consumers, and at the same time promoting charitable giving if the sponsoring website so elects to install and offer the charitable giving associated resources and systems of the Invention.

The advantages of this Invention is to eliminate the negative aspects of existing methods and systems, including but not limited to fees to join, high levels of sales and marketing expenses, high levels of continuing education, requirements to recruit members, lack of flexibility in designated parties to benefit by allocated Rewards, and a lack of Upstream Rewards sharing to Members or Charity Members.

Another advantage of the Invention is to finally incorporate meaningful efficiencies enabled by advancing software and Internet technologies to streamline business methods and attendant costs to derive price and quality benefits to consumers.

The invention also enables those e-commerce websites utilizing the technology to allow substantial customization and control over the features, benefits and reporting tools and technologies and methods by the actual member client server users.

This Invention enables Rewards associated with Spending to benefit none, one or more Upstream or Downstream profit or non-profit Members, in variable amounts and for variable periods of time.

The above descriptions of the Invention and its specific embodiments are merely for purposes of illustration. They are not meant to be exclusive and only describe some of the main unique features and benefits. Other combinations and descriptions naturally derive and this application claims to protect all reasonable and ordinary variations of the described embodiments and examples, as this application intends to cover the broadest possible scope of construction, interpretation and application.

This invention is designed to be free to participants who register as Members on Sponsor websites, but another embodiment is to require an upfront fee or charge to register and become a Member.

This invention is designed to enable a Sponsor to select features that enables Members to receive Rewards without spending money or spreading the word to third parties who then register as Members.

This invention is designed to enable a Sponsor to select features that enables Members to designate Charity Members to receive Rewards without the designating Member spending money or spreading the word to third parties who subsequently become Members.

### INCORPORATION OF DRAWINGS

The figures and diagrams attached to the provisional applications referenced above and incorporated herein, and the examples below, are merely samples of possible configurations of the DMR technology invention claimed herein and are not meant to be limiting or restrictive as to the inventive application variations hereunder protected.

Further analysis including beta testing of various configurations of this Inventions features and technology on Sponsor websites may reveal variations that prove useful but not specifically described herein, but such variations will amount to “fine tuning” on the application of the Invention to achieve market acceptance and impact, and will certainly reside within the scope of the present invention as claimed and as anticipated by those familiar with related art.

### DETAILED DESCRIPTION OF EXEMPLARY EMBODIMENTS OF THE INVENTION (GLOSSARY AT THE END)

The present invention relates to an online automated network marketing database driven system and method designed to encourage and reward online viral and word-of-mouth user referrals and promotion of products and services via multilevel, network marketing and interactive communities of users without requiring any investment, spending or membership fees by registered users. This invention also covers applications of this technology with set-up, membership or other required fees and charges.

The system, method and database are comprised of one or more central processors managing databases and transactions between the database and third party user activity. The third parties interacting with the system are generally located remotely on other computers or hand held digital devices connected to the world-wide-web or Internet. The interactive online processes enable participants (whether individuals, for profit, not-for-profit, charitable, educational, religious or governmental or other entities) to sign up, register, track, allocate and interact with the sponsoring online e-commerce community features developed and maintained to facilitate efficient word-of-mouth marketing, direct marketing, network marketing or multi-level marketing of the online community's rewards and compensation programs. The software database tabulates transactions by users and allocates compensation, rewards and donations by the criterion selected by a sponsoring e-commerce community website administrator.

The system allows users to make modifications to customize how they interact with the system and how the system computes the rewards and compensation. This inventive system is more powerful and more easily understood and utilized than any existing system designed to promote the growth of member based sales, marketing and networking. The system provides customizable tools for displaying and introducing online community resources and features to electronic databases of third party contacts of potential users through import and export utilities and features that automatically track and managing digital introductions by registered users to prospective third parties. The invented embodiments are referred to collectively as the “DMR” or “Invention” herein. Further embodiments of the Invention follow:

This invention fully automates the management and operations of complex network marketing and related relationship programs.

Moreover this invention enables ease of customization by online e-commerce websites that deploy the invention.

The invention also enables those e-commerce websites utilizing the technology to allow substantial customization and control over the features, benefits and reporting tools and technologies and methods by the actual member client server users.

This invention does not require any investment or purchases by a Party to join and become a Member.

This invention allows multiple levels of registration of Members depending upon their purpose for registering and their desire to receive Rewards in other than purchase credits against goods and services offered by that particular installation of a DMR.

This Invention enables Rewards associated with Spending to benefit none, one or more Upstream or

Downstream Members, in variable amounts and for variable periods of time.

This Invention enables a DMR to select different methods of and computations for computing Rewards for each product and service offered by a Sponsor, and to make changes to these selected criteria at any time.

This Invention enables Members to accept, reject, assign or reduce the amount of Rewards they otherwise are entitled to by the DMR.

This Invention enables a Sponsor to select or activate features that enable a Member to make changes to the previously designated Members or Charities that benefit from that Member's Spending.

This Invention enables Members to query the DMR database and evaluate by levels Upstream or Downstream, by periods of time, and by location of Members impacting their Rewards.

This Invention enables Members to allow some or all of their profiles, locations and activity interacting with the DMR database to be viewable and accessible some or all of the other Members depending upon the criterion they select.

This Invention enables Members to query the DMR database for information on the level of use of features and functions by them and other Members, the level of purchasing of products and services by them and other Members, and many other variables to monitor and evaluate items of interest or disinterest part of the DMR and Sponsor website.

This Invention enables Members to allow some or all other Members to track their location and DMR website activity by various criteria.

This Invention enables Members to receive one or more alerts and notifications at variable timeframes and delivery methods they specify regarding activity tracked and computed by the DMR database impacting them or of interest to them.

This Inventions allows the DMR to receive contact uploads of Members from other databases of the

Members (both on and offline), and allows the Members to direct the DMR on how to and at what frequency to invite the contacts uploaded to visit the Sponsor website and consider utilizing and benefiting by the DMR technology.

This Invention allows the DMR Sponsor to increase or decrease in amount and applicable time period and applicable scope and coverage of purchases of goods and services impacting Rewards applicable to any specific Member.

The DMR enables an unlimited global communication network by and amongst any Party and allows spending by that Party (whether or not they are a Member) to benefit one or more Members by tracking how that Party became aware of the Sponsor website of the DMR.

The DMR enables any Party to decline designating a referring Member to receive credit for their visiting and utilizing the Sponsor website DMR.

The DMR enables a reduction in sales and marketing expenses generally associated with product and service sales, marketing and distribution.

The DMR enables changes in the scheduled Rewards connected to specific products and services that will encourage Member Spending on such products and services.

The DMR enables Members and any visiting Party to know immediately whether purchase of an item of goods or services on the Sponsor website impacts Rewards and Pools or not, and if the Sponsor elects to turn on this technology feature, to also know the extent of the impact on the Rewards and Pools by computational criterion or formula applicable to that item of goods or service.

This Invention allows a Member to designate multiple referring Upstream Members and multiple Charities benefiting by the Members Spending.

When a Member designates multiple Members or Charities to benefit by its Spending, the Member can also designate in what percentage the multiple designated referring members or Charities are to benefit, or allow the DMR to share the benefits equally by default formula.

The DMR enables Members to review and download all associated tax and accounting records and reports, by time period, and associated payment and redemption activity, from all Rewards paid or redeemed by them.

The DMR enables Members to select notification and means of notification whenever Spending impacts their Rewards, or whenever impacts of a specified quantity are reached.

This DMR Invention enables a Member who joins free and never contacts a Party and recruits them to join as a Member to nevertheless benefit by Upstream Spending and to benefit by discounts and specials established by the Sponsor for Member purchases.

This DMR Invention eliminates all pressure to introduce the DMR or Sponsor website to any Party generally associated with all other multi-level and network marketing programs and methods.

This DMR Invention eliminates any conflict of interest amongst Members impacting Reward Pools as it does not allow or provide for any differential compensation of DCCP compensation formula that aggregates Member Rewards and Member Pools and applies complex or undisclosed allocation criterion.

This DMR Invention eliminates any immediate, direct or indirect compensation or other reward for recruiting and introducing a Party to join the DMR as a Member and thereby eliminates the negative energy associated typically with all other multi-level or network marketing systems and technologies and methods.

This DMR fully automates all aspects of Party and Member relationships to a Sponsor website and to each other and eliminates the training education and complex pressured selling associated with all other multi-level or network marketing systems, technologies and methods.

This DMR, if selected by Sponsor websites, allows for Member profiles and Member sharing and searching of profiles to enable business and personal networking online amongst Members irrespective of association Upstream or Downstream and irrespective of Spending.

This DMR Invention enables a limitless number of Members and levels Upstream or Downstream to be tracked and considered for inclusion in impacting Rewards by the Sponsor.

This DMR Invention allows a Sponsor to utilize the features and resources of the DMR without making any investment of capital or equipment and without need to host the DMR program and database on the Sponsor's computers.

This DMR Invention allows integration as a SAAS (software as a service) to any third party website, including those without e-commerce that desire a virtually hosted e-commerce DMR enabled online presence.

This DMR invention enables one or more affiliated or unaffiliated Sponsor websites to share and integrate Member databases and information while separately tracking in distinct databases all activity of Members across the spectrum of impacted Sponsor DMR websites.

The above descriptions of the Invention and its specific embodiments are merely for purposes of illustration. They are not meant to be exclusive and only describe some of the main unique features and benefits. Other combinations and descriptions naturally derive and this application claims to protect all reasonable and ordinary variations of the described embodiments and examples, as this application intends to cover the broadest possible scope of construction, interpretation and application.

The system and method incorporates contact management and network marketing and sales automation tools and techniques into the DMR so registered user Members with little to no selling experience and personality skills can effectively market introductions to the DMR to a large well administered database of existing or new contacts.

### Glossary of Key Terms

“DMR.” Acronym for Direct Member Rewards, which is the name of the inventive embodiment the subject of this application for protection.

“Invention.” The DMR and other unique and protectable embodiments herein.

“Member.” A person or entity that utilizes web browser technology to access the DMR and join as a registered member to the e-commerce or online community website deploying the DMR technology.

“Charity.” A non-profit, government, education or other similar Member.

“Sponsor.” A website that utilizes the DMR technology.

“Upstream.” A Member with a direct or indirect relationship to a subsequent Member.

“Downstream.” A Member with a direct or indirect relationship to a prior. If Member B joins and designates Member A as the referring Member, Member A is Upstream from Member B who is Downstream to Member A.

“Related Member.” A Member who is Upstream or Downstream from another Member A and whose Spending impacts Rewards of Member A.

“Spending.” Payments for goods and services by a Member that impacts the computation of rewards and compensation tracked by the DMR.

“Rewards.” The amount of compensation or other benefits computed by the DMR and allocated to and amongst Members.

“Donation.” The amount of Reward allocated to a Charity Member based on a Member spending.

“Pool.” The total computed rewards and compensation from Spending impacting a specific Member.

“Party.” Any individual or entity of any type or nature part of the global community of Internet users that is not yet a Member of a Sponsor's DMR.

### Example Applications of Embodiments

### Example I

A Sponsor creating and operating an online wellness community targeting healthy lifestyles, natural health and integrative/preventive medicine enthusiasts and professionals decides to license and integrate a DMR system. The objective is to create an interactive community similar to WebMD.com. Sponsor desires to reward people who register with Sponsor's website as a Member for referring Sponsor's website to third parties. Sponsor integrates the DMR application and allows users to register and become Members. The DMR compensation terms selected pay 10 levels for 10 years. Level 1 pays 3%, level 2 pays 2% and levels 3 through 10 pay 1% each, for a total potential payment of 13% in referral Rewards on a Member's spending. The Sponsor also enables charitable contributions and pays to the charity designated by a Member 1% of that designating Member's sending plus 1% of the spending of all level 1 downstream directly referred Members by the designating Member. The charitable donation rewards are set up as perpetual and do not stop resulting from a Member's spending 10 years after that party became a Member. The non-charitable donation component of Rewards based on a Member's spending is selected to stop 10 years after that Member first registered. The Sponsor makes registering as a Member completely free and enables full Reward and Donation participation without requiring a Member to ever buy product or services from Sponsor. The Sponsor incorporates upgrade membership features not part of the free membership including automated sales and marketing communications and tool sets for professionally building a Member's downstream membership.

### Example II

A Sponsor creating and operating an online artist community targeting aspiring to professional artists and their customers, resellers, interior designers and other industry enthusiasts. All types of artists are covered from visual artists, to literary artists to music artists without these categories meaning to be limiting. Sponsor decides to license and integrate a DMR system to reward parties who register as Members on its website who refer third parties to Sponsor's website. Sponsor integrates the DMR application and allows users to register and become Members. The DMR compensation terms selected pay 5 levels for the life of a Member. Level 1 pays 5%, level 2 pays 3% and levels 3 through 5 pay 2% each, for a total potential payment of 14% in referral Rewards on a Member's spending. The Sponsor also enables charitable contributions and pays to the charity designated by a Member 5% of that designating Member's. The Sponsor makes registering as a Member completely free, does not require Member to ever buy product or services from Sponsor, but beginning in year 2 after first registering (the anniversary date of membership), Sponsor charges $19.95 per year in advance to maintain Member's participation in Rewards and Sponsor donates the initial registration fee to the Sponsor's main designated charity. Any Member spending thereafter benefits the Charity designated by Member. Sponsor also allows Member to change their designated Charity once each calendar year. Sponsor also elects to make the first $100 of each Member's Rewards in any calendar year payable only in purchase credits on Sponsor's website, with Reward payment in cash contingent upon a Member's Reward account balance exceeding $100.

### Example III

A Sponsor creating and operating an online travel community targeting travelers as well as lodging, guest services and activity providers, and other hospitality businesses and customers. Sponsor decides to license and integrate a DMR system. The objective is to create an interactive community similar to BedandBreakfast.com or leading travel sites. Sponsor desires to reward people for referring Sponsor's website to third parties and also provide registered users discounts. Sponsor integrates the DMR application and allows users to register and become Members. The DMR compensation terms selected pay 3 levels for 5 years. Level 1 pays 3%, level 2 pays 2% and levels 3 pays 1%, for a total potential payment of 6% in referral Rewards on a Member's spending. The Sponsor does not enable charitable contributions or rewards on Member spending. The Sponsor makes registering as a Member completely free and enables full Reward participation without requiring a Member to ever buy product or services from Sponsor.

### Example IV

A Sponsor creating and operating an online new clothing, jewelry, shoe, purse, glasses and related apparel and accessories store targets consumers, resellers, designers and other industry enthusiasts. Sponsor decides to license and integrate a DMR system to reward parties who register as Members on its website who refer third parties to Sponsor's website. Sponsor integrates the DMR application and allows users to register and become Members for a $19.95 initial and annual registration fee. Members also receive 5% off the listed price on any item for registering as Members. The DMR compensation terms selected pay 3 levels for the life of a Member. Level 1 pays 10%, level 2 pays 5% and levels 3 pays 3%, for a total potential payment of 18% in referral Rewards on a Member's spending. The Sponsor enables voluntary charitable contributions and pays to the charity designated by a Member 2% of that designating Member's spending. Sponsor elects to make the first $50 of each Member's Rewards in any calendar year payable only in purchase credits on Sponsor's website, with Reward payment in cash contingent upon a Member's Reward account balance exceeding $50. Sponsor also grants every new Member a $25 purchase credit in its Reward account for joining.

### Example V

A Sponsor creating and operating an online classified community website (new and used products as well as real estate services) decides to license and integrate a DMR system to reward parties who register as Members on its website and who refer third parties to Sponsor's website to either buy or sell goods and services similar to the scope of content on craigslist.com. Sponsor integrates the DMR application and allows users to register and become Members for free. The DMR compensation terms selected pay Members 1% on level 1 and level 2 indirect referrals for a total potential payment of 2% in referral Rewards on a Member's spending. Not all goods and services are included in the Rewards program, only those specifically designated on the website. The items included in the DMR rewards program require payment directly to the Sponsor on behalf of the Member posting in the classifieds as opposed to direct Member to Member transactions as is generally done on craigslist.com and similar sites as well as Sponsor's site for non-Rewards covered goods and services. The Sponsor enables charitable rewards and pays 1% to the charity designated by a Member 2% on that Member's and all level 1 referred Members from the designating Member. Sponsor elects to make the first $50 of each Member's Rewards in any calendar year payable only in purchase credits on Sponsor's website. Sponsor also elects to have unused rewards terminate and expire if not used on or before December 31^{st} of each year.

While the invention is described in terms of a specific embodiment and variations thereof other embodiments and variations of a DMR could readily be adapted by one skilled in the art. Including allocating Rewards (either up front or ongoing) upon joining from upstream members. As an example a new Member could be rewarded for 5% of the spending of the referring upstream Member who referred them to the Sponsor website. If the referring Member referred more than one downstream level 1 new Members, this 5% upstream reward would be shared by all impacted Members. Accordingly, the scope of the present invention is not meant to be limited by the referenced diagrams or examples.

What is claimed as inventive is:

1. A computer database driven interactive software automation system and method (“Invention” or “DMR”) that rewards and computes compensation for interaction between website server databases and Internet connected client computers, Internet connected hand held wireless devices, and other Internet connected electronic digital devices (Remote Users) that expands and automates the dynamic relational and transactional characteristics between the DMR and Remote Users, their designated charities, and the referring registered Remote Users in an electronic commerce enabled social and business online networking environment.

2. A method of claim 1, wherein this residual income and charity donation automation system is offered free (or for a nominal charge) to registered users (“Member” or “Members”) by websites incorporating this DMR Invention (the “Sponsor” or “Sponsors”) for parties (“Parties” or “Party” comprises individuals and/or entities of all types and nature connected to and using the Internet) with no requirement placed upon Parties to pay a membership or registration license fee, purchase any product, or purchase services as a prerequisite to earn Rewards as defined and described below, or to designate one or more Charities as defined below.

3. A method of claim 1, further comprising a software application and method for individuals to be rewarded for introducing other individuals to a Sponsor that integrates e-commerce goods and services with social and business networking technology on community oriented websites.

4. A method of claim 1 wherein the DMR tracks levels of referral between Members and automatically makes them friends (links profiles and communications) for purposes unrelated to goods and service transactions being tracked and reported and managed by the DMR

5. A method of claim 1, wherein multi-tiered or multi-level compensation and rewards of cash or other benefits (“Rewards”) are offered to users who register and become Members and are encouraged to engage in word of mouth viral marketing and promotion of membership in the DMR in order to earn residual Rewards and benefit charities.

6. A method of claim 1, wherein the Rewards are allocated based upon the criterion and attributes selected upon installation and administration of the DMR by the Sponsor.

7. A method of claim 1, wherein the Rewards criterion applied to a specific Member (MA) may derive from activity of one or more Members who joined before MA (Upstream) who directly or indirectly introduced or invited MA to join the DMR.

8. A method of claim 1, wherein the compensation and/or rewards criterion selected and activated by Sponsor and applied to MA may derive from activity of one or more Members who joined after (Downstream) MA and where MA directly or indirectly introduced or invited these parties to join as Members of the DMR.

9. A method of claim 1, wherein Rewards are allocated to member non-profits, religious, educational or government entities (“Charity,” “Charities” or “Charity Members”) based upon the criterion and attributes selected upon installation by the Sponsor.

10. A method of claim 1, being a multi-level marketing or direct network marketing incentive application invention that requires charitable giving as part of its networking rewards technology.

11. A method of claim 1, wherein the Sponsor selects the applicable percentage of a Member purchase of products and/or services to be allocated as Rewards for distribution to Members (the sum of such Rewards from any specific qualifying purchase distributed amongst Members is referred to as the “Pool”).

12. A method of claim 1, wherein the DMR Sponsor selects the applicable period of time from the date of joining as a user or member that Rewards will be allocated and distributed to impacted Upstream or Downstream Members and Charities from Member spending.

13. A method of claims 1, wherein the Sponsor may apply different compensation criterion, or designate Member compensation rights do not apply to associated purchases, to products and services when adding such products and services to the DMR system of products and services available to Members.

14. A method of claim 1, wherein the amount of Rewards is computed by the Sponsor assigning a percentage of Spending by each Member that is part of the Pool that is allocated to Members based upon their referral relationship (as defined by the Sponsor when activating and selecting amongst the variables and features of the DMR) to the spending Member.

15. A method of claim 1, that eliminates the negative aspects and limitations of existing multi-level and network marketing methods and systems including DCCP systems (Differential Continuous Compensation Plans), NDCP systems (Non-Differential Compensation Plans, SSBA systems (Stair Step Break Aways), and existing variants thereof including barriers to entry, retention problems and confusing compensation plans.

16. A method of claim 1, whereby the DMR tracks and allocates Members by layers and levels Upstream and Downstream from each other, and tracks and sorts Members relative to each other to determine if they are relationally direct or indirect Upstream or Downstream Members to each other (“Related Members”), and assigns variables to each other that identifies and sorts Members by levels and relative relationship to each other.

17. A method of claim 1, whereby registered user Members can elect to be automatically connected to Upstream and/or Downstream Members for purposes of sharing profiles and other communications and information of each other.

18. A method of claim 1, wherein the DMR or system allows customized compensation variables to be assigned for each specific product or service uploaded into the e-commerce database, with such customized compensation/reward variables overriding the then applicable default variables.

19. A method of claim 1, wherein the convergent technology elements of this system and method create a comprehensively inventive solution applied to electronic commerce enabled user interactive websites to deliver on the promise of the Internet to disrupt traditional manufacturing, distribution and supply chains and the associated marketing and advertising costs by enabling and empowering an effective comprehensive direct to consumer business system.

20. A method of claim 1, wherein the system and method incorporates automation tools for introducing third party prospective contacts to the DMR and tracks and schedules related communications, responses and registration status based on user selected content and variables.
